(19) United States
(12) Patent Application Publication
(10) Pub. No.: US 2009/0327809 A1
(43) Pub. Date: Dec. 31, 2009

(54) DOMAIN-SPECIFIC GUIDANCE SERVICE FOR SOFTWARE DEVELOPMENT

(75) Inventors: Joseph M. Joy, Bangalore (IN); Gopal R. Srinivasa, Bangalore (IN); Kanika Nema, Karnataka (IN); Sriram Rajamani, Bangalore (IN); Krishna Kumar Mehra, Bangalore (IN); Vipindeep Vangala, Andhra Pradesh (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,611

(22) Filed: Jun. 26, 2008

(51) Int. Cl. G06F 11/00

(52) U.S. Cl. 714/26; 714/E11.026

(57) ABSTRACT

During software development, both before and after release, information may be collected and stored that may provide insight to developers as a generalized service. For example, data from past debugging sessions, source code in various repositories, bug repositories, discussion groups, and various documents may provide relevant information for software developers to fix current problems when this information is coherently matched with the problem. Using various sources, a system may mine the stored data to give the current developer information related to past code development, and reveal why the code changed throughout previous development. Using sophisticated analyses to identify similar code patterns across multiple large software projects, discovering patterns in normal and abnormal uses of particular software interfaces, and employing other mining techniques, a developer may find domain-specific information to facilitate ongoing software development.

### BACKGROUND

This Background is intended to provide the basic context of this patent application and is not intended to describe a specific problem to be solved.

Software developers, especially those are frequently faced with the task of understanding a piece of code, or of trying to understand which part of a complex software system is causing exceptions or other software failures. Very often, these developers (who are relatively inexperienced or otherwise unfamiliar with the components they are modifying or debugging) may consult a more experienced developer, or solicit assistance from web-based discussion group via e-mail or other text-based narrative. Significant problems may arise when a developer seeks assistance for a project that involved a large number of developers or may have been developed long ago. For example, it may be time consuming to finally locate a developer that worked on a troubling portion of an application, past developers may no longer be employed with the current firm, or, with time, developers may have forgotten the reasoning for certain code structures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

During software development, both before and after release, information may be collected and stored that may provide insight to developers as a generalized service. For example, data from past debugging sessions, source code in various repositories, bug repositories, discussion groups, and various documents may provide relevant information for software developers to fix current problems when this information is coherently matched with the problem. Using various sources, a system may mine the stored data to give the current developer information related to past code development, and reveal why the code changed throughout previous development. Using sophisticated analyses to identify similar code patterns across multiple large software projects, discovering patterns in normal and abnormal uses of particular software interfaces, and employing other mining techniques, a developer may find domain-specific information to facilitate ongoing software development.

### BRIEF DESCRIPTION OF THE FIGURES

FIG. 1 may be an illustration of a computer that implements a system and method for domain-specific software development;

FIG. 2 may be a high-level schematic for the domain-specific software development system; and

FIG. 3 may be one example of a method for identifying domain-specific debugging data to resolve an encountered bug or other error.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

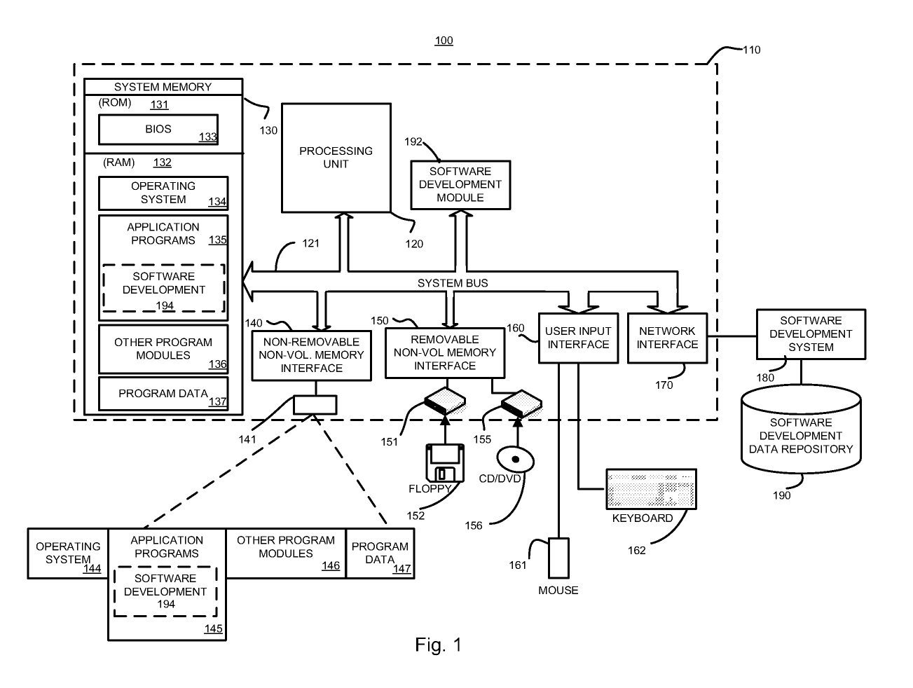

FIG. 1 illustrates an example of a suitable computing system environment 100 that may operate to provide the method described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary computing environment 100.

With reference to FIG. 1, an exemplary computing environment 100 for implementing the blocks of the claimed method includes a general purpose computing device in the form of a computer 110. Components of the computer 110 may include, but are not limited to, a processing unit 120, a system memory 130, and a system bus 121 that couples various system components including the system memory 130, non-volatile memories 141, 151, and 155, Software Development System 180, and Software Development Module 192 to the processing unit 120.

The computer 110 may operate in a networked environment using logical connections to one or more remote computers. In some embodiments, the remote computer is a Software Development System 180. The Software Development System 180 may be in communication with several software development data repositories 190, as further explained below.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The computer storage media may include code that may be executed by the processing unit 120 of the computer system 110. For example, the computer-executable code may assist a software developer in resolving encountered bugs, as explained below. The ROM may include a basic input/output system 133 (BIOS). RAM 132 typically contains data and/or program modules that include an operating system 134, application programs 135, other program modules 136, and program data 137. Some of the application programs (e.g., a Software Development Application, 194) may be a front end or other component for a larger system (e.g., the Software Development System 180) incorporating various local or network resources and other computing environments 100.

The computer 110 may also include other removable/non-removable, volatile/nonvolatile computer storage media such as a hard disk drive 141, a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150 and may contain data and/or program modules or storage for the data and/or program modules of the RAM 132 (e.g., an operating system 144, application programs 145 such as the Software Development Application 194, other program modules 146, program data 147, etc.).

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A display device (not shown) may also be connected to the system bus 121 via an interface, such as a video interface.

A Software Development Module 192 may be implemented as in integrated circuit or other form of hardware device connected to the system bus 121. The Software Development Module 192 may process software development data (i.e., known issue data, previous user crash data, source code data, developer debugging data, etc.) from the program data 137, 147, a remote data source 190, or other sources in the same manner as the Software Development Application 194. In other embodiments, the Software Development Module 192 is a component of another element of the computer system 100. For example, the Software Development Module 192 may be a component of the processing unit 120, and/or the Software Development System 180.

A bug may be an error during execution of a computer-executable process or application. The bug may be an error in the logical structure of a program or a syntax error, such as a spelling mistake. Some bugs may cause a program or application to fail immediately, while others remain dormant, causing problems only when a particular combination of events occurs. The process of finding and removing errors from a program is called debugging.

As previously discussed, data may be collected during the software development and debugging process that may be invaluable to developers. The data may be used by later developers to ensure the smooth function and interoperability of applications both before and after the applications are released as a product or a component of another product. One embodiment may make the development data available to a developer in a timely manner and include a sophisticated search process to provide information that is relevant to the domain of a current problem the developer is facing. For example, information from past development and debugging sessions by experienced developers facing similar problems may be helpful if the past sessions were recorded and retrieved in a relevant fashion. Other sources of development and debugging data may include source code repositories, various bug repositories, discussions group logs, and various documents that have been prepared during software development. Generally, the development and debugging data may give the present day developer much more insight into the evolution of the code, how the code changed over the years, and why were these changes made. The development and debugging data may be analyzed to identify patterns across multiple, large software projects that are similar to the portion of code being debugged. In some embodiments, patterns in normal and abnormal uses of particular software interfaces may be useful to the developer.

A debugging service (e.g., the Software Development System 180) may communicate with a developer's local computer 110 (e.g., the Software Development Module 192 or Software Development Application 194) to analyze the development data 190 using pluggable analysis units to extract timely, useful, and domain-specific information. The Software Development System 180 may provide a “quasi real time” interface to facilitate the debugging process in that an initial, first set of results may be returned quickly from a query to a local repository and a more detailed, second set of results may be further developed from the query to a remote, extensive data repository. In some embodiments, the Software Development System 180 receives a message from a developer that includes information related to a particular problem the developer is facing, the Software Development System 180 analyzes the received problem, and returns a consolidated set of results in near real time. In other embodiments, the Software Development System 180 is an automated expert over all aspects of a large, evolving software project.

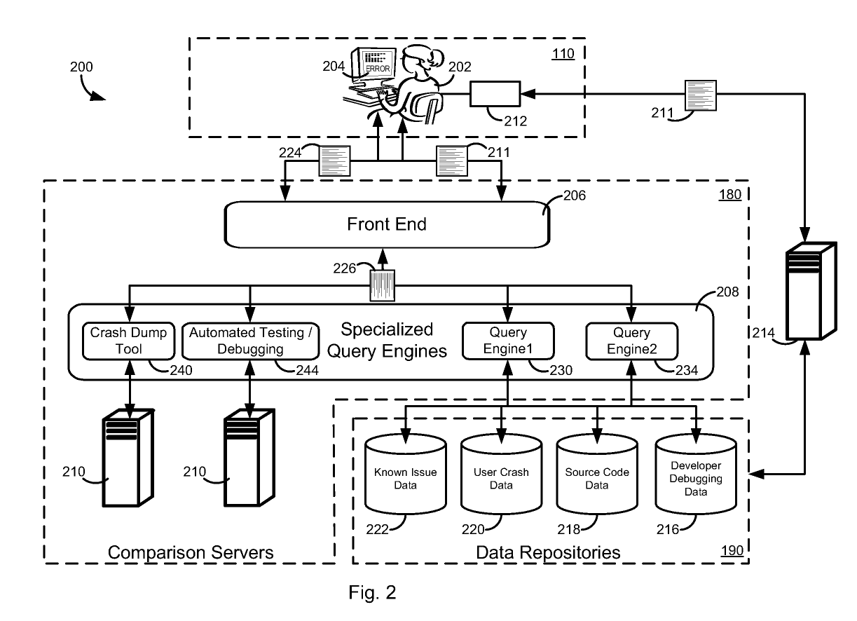

With reference to FIG. 2, a Debugging Service 200 may include a variety of different components to provide quasi-real time, domain-specific debugging assistance to a developer 202 during software development. In some embodiments, the Debugging Service 200 includes a computer 110 at which a developer 202 encounters a bug 204 or other error. The computer 110 may be in communication with a Software Development System 180. The Software Development System 180 may include a front end 206 to process queries and software development and debugging data 211, one or more specialized query engines 208 to manage special data encountered within queries and the data within the repositories 190, and one or more comparison servers 210 to conduct static and runtime program and bug 204 analysis. The Software Development System 180 may also be in communication with one or more data repositories 190. While the computer 110, Software Development System 180, and data repositories 190 are illustrated in the Debugging Service 200 as separate entities, they may be either logically or physically joined or separate and may include any component as generally described in the computing environment 100. Further, while the various components of the Debugging Service 200 include numerous arrowed lines indicating communication between specific components, these lines are for illustration purposes only. Any component of the Debugging Service 200 may be communicatively connected to any other component as herein described.

The computer system 110 may capture development and debugging data 211 related to a portion of code that results in a bug 204. In some embodiments, a debugging recorder 212 may store development and debugging data 211 to the data repositories 190 and may also store a version of the development and debugging data 211 locally on the computer system 110. Alternatively or additionally, an application program 135, 145 may gather and send development and debugging data 211 to the Software Development System 180 front end 206 for further processing and storage to the data repositories 190. Development and debugging data 211 may include any information, documents, code segments, and other data that is related to software development and other actions and events that occurred before, during, or after a user or developer 202 encounters a bug 204.

The debugging recorder 212 or application program 135, 145 that gathers development and debugging data 211 may execute in the background of the computer system 110 or may be activated by one or more events or bugs 204 or a sequence of events encountered by a developer 202 during software development or other activities. An error or encountered bug 204 may be followed by another event, such as the developer 202 editing code related to the error 204, the developer 202 sending an e-mail that includes an error code or otherwise associates the e-mail with the error 204, or other event. The error or bug 204 alone or the combination or sequence of the error 204 and code editing performed by the developer 202 may enable the capture and storage of development and debugging data 211. The captured development and debugging data 211 may include any information related to the bug 204. For example, “hard” development and debugging data 211 may include data related to the state of the computer system 110, including core dumps, stack traces, hardware and configuration data related to the computer system 110, and any other computer system 110 specific data. “Soft” debugging data may include subsequent actions taken by the developer 202 to resolve the error 204, email threads, meeting notes, whiteboard sessions, version information, portions of code, and other information related to the bug 204. Alternatively or additionally, the System 180 may capture different versions of the error-causing code. For example, versions may be stored that represent the code at the time of the error 204, while addressing the error 204, or after the error 204 was resolved.

The debugging recorder 212 or application 135, 145 may also be in communication with a debugging log server 214, System 180 front end 206, or other device that may tag and organize the data recorded by the debugging recorder 212 for storage in the one or more data repositories 190. In some embodiments, portions of code or other information captured or created by the debugging recorder 212 may be tagged with various other data and metadata to facilitate future reference to the information. For example, other data and metadata may include a developer identification, a time stamp, a project identification, a machine identification, or other information. The development and debugging data 211 may be stored in a developer debugging data repository 216 or may be stored locally at the computer system 110 and include one or more references or tags that associate the information with the error 204 or other situation that the developer 202 originally encountered.

The data repositories 190 may store the various types of development and debugging data 211 to be used by the Debugging Service 200 to resolve errors and other compilation or execution bugs. The data 211 may be stored manually by a developer 202 or other person or service during the development process. Alternatively or additionally, the data 211 may be automatically recorded by another application, for example, the debugging recorder 212, as previously described, that is running in the background on a developer's computer 110 or that is otherwise in communication with the developer's computer 110 and the data repositories 190 during programming activities. The data may be stored in any format that allows identification of individual elements (e.g., words, tokens, etc.) and comparison of the elements with other documents. In one embodiment, the data 211 is stored in the data repositories as XML data or as data that may be retrieved using SQL commands and manipulated using database programming techniques. The debugging recorder 212 or other application or device may also execute in the background of a user's computer to automatically record various events and data that are associated with bugs occurring during execution of an application of process on a user's machine.

The data depositories 190 or the computer system memory 130, 141 may include any data that facilitates the debugging process and may be stored manually or automatically, as previously described. In some embodiments, the data repositories 190 include developer debugging data 216, source code data 218 (including data related to various versions of the code, the code itself, and associations with various portions of code), user crash data 220 (including core dumps from user-encountered errors, data from automated crash data gathering applications such as the Dr. Watson® tool as produced by the Microsoft Corporation of Redmond, Wash., or other automated user tools), and known issue data 222 (including documents, code segments, hyperlinks to web-based documents and data, and other information describing previously-encountered errors and other topics related to identified problems).

Other types of data may be stored to facilitate resolving a bug 204. One example of stored data are code change histories of code related to the bug 204. That is, “code” may be a portion of the process that resulted in the bug 204 that is relevant to the given state of the process. A starting point of the code may be indicated by the functions that are on the computer system 110 stack at the time of the bug 204. Other stored data may be links to other bugs that are related to the bug 204, and links and other documentation related to the code. Of course, other types of data may be stored in the data repositories 190 including messages, documents, e-mails, discussion group posts, design documents, whiteboard sessions, and other information gathered during the initial development and subsequent modification of the application or code that resulted in a bug 204. Further, the repositories 190 may include cross-referenced information that is accumulated over time and related to a plurality of software development projects.

The Software Development System 180, debugging recorder 212, debugging log server 214, or other elements may process information stored remotely in the data repositories 190 and locally on the computer system 110 to facilitate relevant searching by the developer 202 to resolve a bug 204. In some embodiments, the data within the data repositories 190 may be cleaned, organized, and weighted for subsequent searching. The data within the data repositories 190 may be one or more of cleaned, organized and weighted at any time before, during, or after a query 224 to resolve a bug 204, as further explained below.

Cleaning the data 211 within the repositories or the queries 224 may involve any technique to remove data that is not relevant for resolving a bug 204. For example, the front end 206 or other element may remove stopwords and other irrelevant data. Memory addresses or other computer system 100 specific data, white space, and commonly used natural language words (e.g., a, an, the, etc.), may be removed when it is not relevant to retrieving generalized information to resolve the bug 204. For example, while a memory address specific to the computer system 110 that encountered the bug 204 may only be relevant to that specific system, and, thus, removed from the data 211 or the query 224, 226, a hardware configuration, core dump, stack trace, or other data that is common to more than one system that encountered the same bug 204 may be a relevant search term to resolve the bug 204 and may not be removed.

Organizing the data 211 or the query 224 may involve any technique to facilitate finding information to resolve a bug 204. In some embodiments, organizing the data includes tokenizing one or more of the query 224 and the data within the data repositories 190. Tokenizing may include separating one or more relevant words or groups of words that remain after cleaning into discrete objects or other elements that may be individually evaluated to resolve the bug 204. Tokenizing may also include grouping elements based on an evaluation of context. For example, elements of the query 224 or the data 211 within the repositories 190 may include the words “linked” and “list.” The System 180 may determine that, if the words are contextually proximate to each other, the words may be relevant to resolving the bug 204 and may be joined to form the single token “linked list.” Of course, the System 180 may use other data mining techniques to determine the relevancy of tokens including word distance to other elements of the query 224, frequency, statistical measurement, and other methods. The front end 206 or other element may also alter the query 224 by cleaning and organizing the query 224 to form a formatted query 226 that may be passed to one or more of the specialized query engines 208 to further resolve the bug 204.

Weighting the data 211 or the queries 224, 226 may include assigning a weight to portions of the data 211 (e.g., the previously-described tokens) that are determined to be relevant to resolving the bug 204. For example, a higher weight may be assigned to unique elements that define the source or subject of the bug 204 or the most relevant elements of the examined document or query 224, 226. In some embodiments, a Term Frequency-Inverse Document Frequency (tf-idf) weight may be assigned to one or more elements or tokens of the data 211 within the repositories 190 and the queries 224, 226. The assigned weight may be a statistical measurement to evaluate the importance of an element to the data within the repositories 190 and to the query 224, 226 itself. The importance of an element may increase proportionately to the number of times the element appears in the document, but may be offset by the frequency of the word in the collection. A weighting scheme (tf-idf weighting, for example), may allow the System 180 to score and rank the relevance of a document or other source of information within the data repositories 190.

The term frequency may be a number of times a given word, token, or other discrete portion of a document appears in the document. The number may also be normalized to avoid bias toward longer documents that may include a higher frequency of the term regardless of the actual importance of the term in the document. For example, one measure of the importance of a term, ti within a document dⱼ may be represented mathematically as:

$${tf}_{i , j} = \frac{{n}_{i , j}}{{\sum }_{k} {n}_{k , j}}$$

where nᵢⱼ is the number of occurrences of the term in document dⱼ, and the denominator is the number of occurrences of all terms in document dⱼ.

The inverse document frequency may be a measure of the importance or relevancy of the term in the context of the document. For example, one measure of the inverse document frequency may be described in terms of the total number of documents in a collection of documents (e.g., the data repositories 190) and the number of documents in the collection that include the term, or:

$${idf}_{i} = log \frac{\vert D \vert}{\vert \{ {d}_{j} \text{:} {t}_{i} ∈ {d}_{j} \} \vert}$$

where |D| is the total number of documents in the data repositories 190 and |{dⱼ: tᵢ ∈ dⱼ}| is the number of documents in the data repositories 190 that include the term tᵢ.

Thus, the importance of an element within a query 224, 226, or the data 211 within the data repositories 190 may be described as:

tfidf_{i,j}=tf_{i,j}·idfᵢ

The tf-idf weight may also filter out irrelevant terms. For example, a high tf-idf weight assigned to an element of the query 224, 226 or the data 211 within the repositories 190 means that it appears a large number of times within a given document, but does not appear in a great many documents within the data repositories 190.

Weights may be assigned to any portion of the development and debugging data 211 and the query 224, 226. For example, weights may be assigned to elements of a stack trace using tf-idf or other techniques. Term pairs that are consecutively ordered in the stack trace may be more relevant than non-consecutive term pairs. In other words, consecutive term pairs may give importance to the sequencing of functions on the stack, and less commonly occurring term pairs may be given higher weights.

The state of the computer system 110 that encountered the bug 204 may also be represented as (key, value) pairs. By representing the computer system 110 state as (key, value) pairs, the computer system 110 state definition may be extended and customized to facilitate resolving encountered bugs 204. The weights may also be used in the vector space model together with cosine similarity as a measure of document similarity, where the measure of documents' similarity may be represented as distances within the vector space.

In operation, the development and debugging data 211 stored in the data repositories 190 may be retrieved with the Service 200 using one or more of the specialized query engines 208 by receiving and processing the query 224, 226. The retrieved information may be employed by a developer 202 or by an application program to facilitate resolving an encountered bug 204 using the Software Development System 180 and the computer 110. In some embodiments, a developer 202 may encounter a bug 204 or other error during execution or development of an application program 135, 145. The developer 202 may engage the Software Development System 180 and the data repositories 190 to facilitate resolving the bug. In other embodiments, the developer 202 may formulate the query 224 and send it to the front end 206 of the Software Development System 180. For example, the computer 110 or the debugging recorder 212 may include an application program 135, 145 that assists the developer in manually formulating the query by including a fillable form that may be completed by the developer 202. Additionally or alternatively, the query may be fully or partially completed automatically by an application program 135, 145 of one or more of the computer 110 and the debugging recorder 212. For example, the application program may formulate the query 224, 226 by detecting a bug 204 or other error and gathering information from the computer 110.

Whether manually or automatically formulated, the query 224, 226 may include any information that may be related to the bug 204 and that may facilitate resolving the bug 204. For example, the query 224, 226 may include an email message or other text-based description of the bug 204. The query 224 may also include hyperlinks to other information related to the bug 224. The hyperlinks may direct the Software Development System 180 to other information including logs of remote debugger sessions stored in the developer debugging data repository 216, or a link including a bug 204 number that identifies the issue in a known issue data repository 222, or a link to any other information in any of the data repositories 190 or elsewhere. The query 224 may also include state information about the computer 110 that encountered the bug 204. For example, state information from the computer 110 may include a current stack trace from the computer 110, or other information related to the various systems of the computer 110 at the time the bug 204 occurred. Information gathered by the debugging recorder 212 may also be included in the query 224.

The computer system 110 may be communicatively linked to the Software Development System 180. The System 180 may include a front end 206 that may receive and initially process the query 224, 226. For example, the front end 206 may determine a structure or contents of the query 224, 226, clean, organize, and weight the query, as previously described, explore links embedded in the query 224, 226, and invoke the specialized query engines 208 to further resolve the bug 204.

In some embodiments, the front end 206 may recognize an element of the query 224, 226 as specialized data other than plain text that may be used in a specialized search of the data repositories 190. For example, the front end 206 may identify an element of the query 224, 226 as a core dump, a stack trace, an identification number associated with a known problem, source code, a hyperlink, a data file, or other information. Identification of specialized data by the front end 206 may also permit the front end 206 to invoke one or more specialized query engines 208. For example, identification of a stack trace within a query 224, 226 may invoke a specialized query engine that is specifically designed to analyze a stack trace and find relevant documents within the computer system 110 or the data repositories 190 that are relevant to the stack trace to resolve the bug 204.

Continuing with the example, the Query Engine1 230 may be configured to process a stack trace that includes data from the computer system 110 as it existed at the time of the bug 204. The specialized query engine 208, Query Engine1 230, may then analyze the stack trace to prepare it for comparison to the data 211 within the data repositories 190. In some embodiments, one or more of the Query Engine1 230 and the front end 206, cleans, organizes, and performs tf-idf weighting of the query 224 and the stack trace, as previously described.

In a further embodiment, one or more of the Query Engine1 230 and the front end 206 may parse the repositories 190 for stack traces, and store the stack traces separately in a full-text indexed database. For example, when a user 202 issues a query 224, 226, the tool first parses the query 224, 226 to determine if it contains one or more stack traces. If a stack trace is found, a full-text search may compare the stack trace found in the query in the data in the data repositories 190. If the comparison finds a match between the query stack trace and the data of the repositories 190, the match may be ranked. In some embodiments, ranking the match may including using an algorithm that is implemented by full-text engines, for example, the Microsoft Full Text Engine for SQL Server™ as produced by the Microsoft Corporation of Redmond, Wash. The Service 200 may obtain the longest common substring between the query stack trace and each of the matches found in the repositories 190. The results may be ranked by both the length of the longest common substring, which is given higher priority, and the number of such substrings found during each comparison. Alternatively, intelligent substring matching may be performed using a suffix tree that is created using Ukkonen's algorithm as described in “Algorithms on Strings, Trees, and Sequences” by Dan Gusfield.

In a still further embodiment, unsupervised K-means clustering over the repositories 190 may be implemented as a search technique. For example, debugging logs or other types of data within the data depositories may be grouped into a single cluster. The clusters may be formed at any time, for example, offline, and stored in a central database that is a component of the repositories 190 or separate from the repositories 190. When a user submits a query 224, 226 the query data (e.g., debug log, system and/or stack state, etc) may be used to identify the relevant cluster (among K clusters) using cosine similarity. The identified cluster may contain relevant topics that match the submitted query 224, 226. Each cluster may have many relevant logs, traces, or other data. To narrow the amount of relevant data, within identified clusters, the top-N relevant matches may be presented or returned to the user. The results may be displayed in a ranked fashion, for example, in decreasing order of cosine distance.

One or more of the comparison servers 210 may employ one or more of the techniques described above to compare the stack trace to the development and debugging data 211 stored locally on the computer system 110 and the data within the data repositories 190. The comparison may return any number of documents and other data from one or more of the local computer system 110 (e.g., from memory 130, 141) and the data repositories 190. The returned documents are relevant to resolving the bug 204. For example, the returned documents may answer various questions a developer encountering the bug may face, such as “where is this function defined,” “where else is it used,” “what is this variable type,” and “what person/group would most likely have personal experience with this code?”

The specialized query engines 208 may be configured as one or more “pluggable” analysis units. For example, specialized query engines 208 may include one or more discrete APIs that may be optionally integrated into the System 180 as desired by the developer 202 or other entity. The engines 208 may include one or more of a tool 240 that investigates crash dumps, such as the !analyze tool as produced by the Microsoft Corporation of Redmond, Wash. The tool 240 may also capture a record of past issues in the form of rules to address bugs 204 and other errors. The specialized query engines 208 may also include an automated testing and debugging application 244. For example, a query engine incorporating scientific method debugging techniques from the Delta Debugging project as developed at the Software Engineering Chair at Saarland University in Saarbrucken, Germany may be included as one or more of the specialized query engines 208. Of course, many other specialized query engines 208 may be incorporated into the System 180 including, as previously described, Query Engine1 that may retrieve documents or other information to facilitate resolving a bug 204 based on a specialized form of input (e.g., a core dump, a stack trace, computer system state data, and other items that may be incorporated into the query 224, 226), Query Engine2 that may retrieve information based on plain text or other input, and other pluggable APIs that may retrieve information based on one or more of the query items as previously discussed, including hyperlinks, error identification numbers, code segments, key words, and other data.

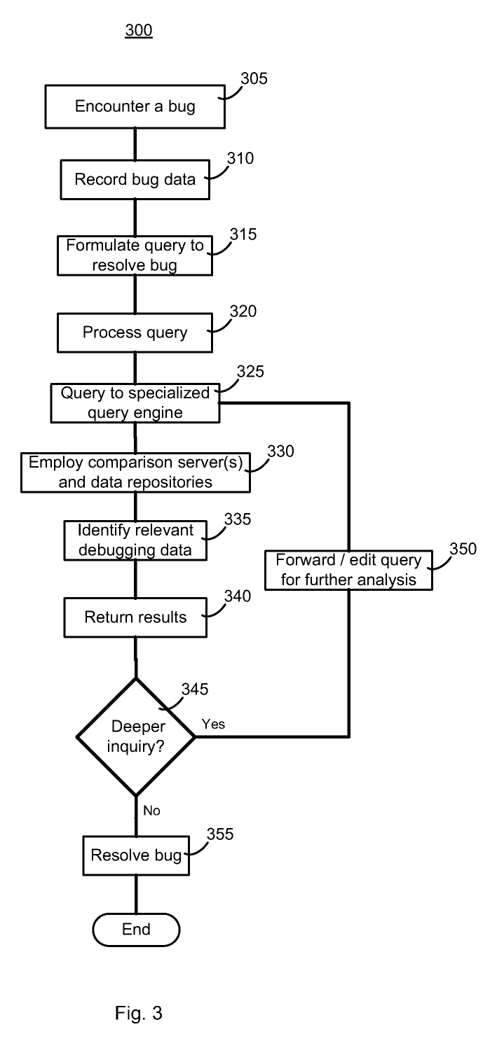

With reference to FIGS. 1-3, a method 300 may employ one or more components of the Debugging Service 200 to provide a developer 202 or other entity with documents and other information to facilitate resolving a bug 204 or other computer system 110 error. The method 300 may include one or more blocks including tasks that may be preformed in any order to provide information that is related to the domain of an encountered bug 204.

At block 305, a user or software developer 202 may encounter a bug 204 or other error during execution of a computer-executable process or other application. As previously described, the bug 204 may be related to software that the developer 202 is currently encoding or to an application executing on computer system 110 or a remote computer system.

At block 310, an application may be running in the background of the computer system to record development and debugging data 211 related to the bug 204. The application may be continuously running in the background while the computer system 100 is powered, may be running once a developer instantiates a code editing application, or may begin running upon the combination of various events or user/developer 202 activities. As previously described, some of the development and debugging data 211 recorded may be core dumps, stack traces, computer system 100 state information, code segments, and other “hard” or “soft” information. The data 211 may be sorted or processed by one or more of the front end 206 and a debugging log server 214 and recorded locally or within one or more data repositories 190, for example, a developer debugging data repository 216. Of course, many other types of current or past bug-related data may be recorded to other repositories including a known issue data repository 222, a user crash data repository 220, and a source code data repository 218.

At block 315, the user or developer 202 may formulate one or more queries 224 to resolve the bug 204. The query may be manually or automatically formulated and may include any information that is relevant to resolving the bug 204. For example, the query 224 may include a plain text message, one or more key words, hyperlinks to data related to the bug, code segments, error messages, identification numbers to other known errors or code segments, or other hard and soft data, as previously described.

At block 320, the method 300 may process one or more of the query 224, 226 and the recorded development and debugging data 211. In some embodiments, the front end 206 may receive a query 224 or development and debugging data 211 from the computer system 110. The front end 206 may also clean, organize, and weight, as previously discussed, one or more of the query 224 and the development and debugging data 211 recorded by the debugging recorder 212 or another source. Completion of block 320 may result in a formatted query 226 or formatted development and debugging data 211. The formatted debugging data may be stored as described in relation to block 310.

At block 325, the query 224 or formatted query 226 may be requested by otherwise communicated to one or more of the specialized query engines 208. As previously described, each of the one or more specialized query engines 208 may be optionally integrated into the System 180 to analyze the query 224, 226 to discover information to resolve the bug 204. Further, each of the engines 208 may be configured to process and analyze a specific type of information that is identified within the query 224, 226 and the data repositories 190. For example, Query Engine1 230 may be configured to process a stack trace that includes descriptions of the functions that were executing on the computer system 100 at the time of the bug 204, while Query Engine2 234 may be configured to process and analyze plain text information.

At block 335, one or more elements of the System 180 may be engaged to identify development and debugging data 211 that is most relevant to resolving the encountered bug 204. In some embodiments, the method 300 may compare the query 224, 226 to the development and debugging data 211. For example, one or more of the specialized query engines 208 may employ one or more comparison servers 210 and the computer system 110 memory 130, 141 or the data repositories 190 to compare the query 224, 226 and the development and debugging data 211. To identify the most relevant information for resolving the encountered bug 204, the method 300 may compare individual tokens or other elements of the query, as previously described, to the weighted development and debugging data 211.

To identify the relevant information to the developer, the method 300 may be configured to compare the query 224, 226 to the development and debugging data 211 stored locally at the developer's computer system 110 and in the data repositories 190. In some embodiments, the method 300 may perform a database join or other technique to identify common elements of the query 224, 226 and the data 211. The most relevant documents and other data may be identified by those documents having highly relevant terms that are common to terms of the query 224, 226. For example, the method 300 may be configured to identify a first set of relevant data from the development and debugging data 211 stored locally at the computer system 110, and to provide a second set of relevant data from the remote data repositories 190 or any combination of the computer system 100 memory 130, 141 and the data repositories 190. Further, the method 300 may identify the second set of relevant data by refining the first set of relevant data. The first and second sets of relevant data may provide the developer 202 with varying degrees of detail and analysis of the encountered bug 204.

The development and debugging data 211 stored in the computer system 110 memory 130, 141 and the data repositories 190 may be weighted at any time prior to identifying the relevant data, for example, as the debugging data is stored or during the comparison of the query 224, 226 to the data 211. The data 211 may be weighted using tf-idf techniques, as previously described, or any other method to more easily identify the data 211 that is most relevant to resolving the encountered bug 204.

At block 340, the first or second sets of relevant data may be returned to the developer 202. In some embodiments, a message, e-mail, or other information is sent to the developer 202 that includes the first or second set of relevant data. The message may include one or more links to various documents and data 211 within the computer system 110 memory 131, 140 or the data repositories 190. The message may also include the actual documents and data from the sources.

At block 345, the method 300 may determine if a further or deeper inquiry into the encountered bug 204 is required. For example, if only the first set of relevant data was returned to the developer 202, the developer 202 may choose to execute a deeper analysis by, at block 350, forwarding the query back to the one or more specialized query engines 208 for further analysis. Additionally or alternatively, the developer may amend or edit the query to provide more or less detail about the bug 204. If, however, the developer 202 or other entity is satisfied with the results returned at block 340, the method 300 may, at block 355, implement changes identified or suggested by the relevant development and data 211, and end.

Thus, a Debugging Service 200 may be employed using a method 300 to record and identify development and debugging data 211 for later retrieval to resolve encountered bugs. The functionality of the Service 200 may be as loosely coupled as possible to ensure both independent software development and research into debugging issues, while remaining broadly applicable to all aspects of software development. Including one or more pluggable analysis units in the form of specialized query engines 208, the Service 200 and method 300 may provide information to developers that has been collected and assembled from past and present software development to resolve encountered bugs. Further, by returning both a first and second set of relevant debugging data, the Service 200 and method 300 may return relevant information in a timely, “quasi-real-time” fashion, thus increasing the efficiency of development and the consistency of the code for future development.

Much of the inventive functionality and many of the inventive principles described herein are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions, programs, and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

1. A computer system comprising a processor for executing computer executable code, a memory for storing computer executable code, and an input/output device, the processor being programmed to execute computer executable code for identifying data that is relevant to resolving a bug encountered by a software developer, the computer executable code comprising code for:
capturing development and debugging data related to design and development of a computer-executable process;
encountering a bug during execution of the computer-executable process on the computer system;
formulating a query including information related to the encountered bug;
tokenizing the query into one or more relevant query elements and the development and debugging data into one or more relevant debugging elements;
comparing the relevant query elements to the relevant debugging elements; and
identifying a relevant set of data from the development and debugging data using one or more information retrieval techniques, wherein the relevant set of data includes one or more documents including a higher-weighted relevant debugging element that matches one or more of the relevant query elements.

2. The computer system of claim 1, wherein capturing development and debugging data related to design and development of a computer-executable process comprises storing development and debugging data in one or more data repositories, the development and debugging data including one or more of data related to a state of the computer system and data related to subsequent actions taken to resolve a previous error related to the encountered bug.

3. The computer system of claim 1, wherein the development and debugging data includes one or more of a core dump, a stack trace, hardware configuration data, and data specific to a state of the computer system as it encountered the bug.

4. The computer system of claim 1, wherein the development and debugging data includes one or more of email threads, meeting notes, whiteboard sessions, version information, code change histories, and portions of code from the design and development of the computer-executable process.

5. The computer system of claim 1, wherein the encountered bug is an execution error of the computer-executable process.

6. The computer system of claim 1, wherein the information related to the encountered bug includes one or more of a core dump, a stack trace, an error identification number, a hyperlink, and a plain text description of the encountered bug.

7. The computer system of claim 1, wherein tokenizing one or more of the query and the development and debugging data into relevant elements includes one or more of removing whitespace, stopwords, and commonly used natural language words, identifying relevant elements, and separating the relevant elements into discrete objects, wherein stopwords include memory addresses and the discrete objects include one or more relevant elements that are contextually related to one or more of the bug or the development and debugging data.

8. The computer system of claim 1, wherein tokenizing the query into relevant elements includes grouping the relevant elements into discrete objects based on a contextual proximity to other elements of the query.

9. The computer system of claim 1, wherein one or more information retrieval techniques includes assigning a higher weight to the relevant debugging element if the relevant debugging element occurs more frequently than another relevant debugging element, the higher weight offset by the frequency of the relevant debugging element in the captured development and debugging data.

10. The computer system of claim 1, wherein the one or more information retrieval techniques includes one or more of tf-idf weighting, clustering, and full-text searching.

11. The computer system of claim 10, wherein clustering includes identifying and ranking one or more relevant sets of data based on a distance from a cluster, and full-text searching includes matching a longest common substring between one or more of the relevant debugging elements and the relevant query elements.

12. The computer system of claim 1, further comprising evaluating an importance of each relevant debugging element to the captured development and debugging data.

13. The computer system of claim 1, wherein comparing the relevant query elements to the relevant debugging elements includes performing a database join.

14. The computer system of claim 13, wherein elements of the database join correspond to captured development and debugging data that is most relevant to resolving the encountered bug.

15. A computer storage medium comprising computer executable code for identifying information to resolve an error of a computer-executable process that is encountered during software development, the identifying comprising:
capturing development and debugging data during design and modification of a computer-executable process;
encountering an error during execution of the computer-executable process on the computer system;
formulating a query including information related to the encountered bug;
tokenizing the query into one or more relevant query elements and the development and debugging data into one or more relevant debugging elements;
assigning a weight to each relevant debugging element using one or more information retrieval techniques;
matching the relevant query elements to the relevant debugging elements; and
identifying a relevant set of data from the development and debugging data, wherein the relevant set of data includes one or more documents including a higher-weighted relevant debugging element that matches one or more of the relevant query elements.

16. The computer storage medium of claim 15, wherein the development and debugging data includes one or more of a state of a computer system executing the process during the error, design data recorded during an initial development of the process, and previous versions of code for the process.

17. The computer storage medium of claim 15, wherein the debugging data includes one or more of hard data and soft data, the hard data including one or more of core dumps, stack traces, hardware configuration data, and data specific to a computer system as it encountered the error, and the soft data including one or more of email threads, meeting notes, whiteboard sessions, version information, code change histories, and portions of code from the computer-executable process.

18. The computer storage medium of claim 15, wherein the one or more information retrieval techniques includes tf-idf weighting, clustering, and full-text searching, wherein clustering includes identifying and ranking one or more relevant sets of data based on a distance from a cluster and full-text searching includes matching a longest common substring between one or more of the relevant debugging elements and the relevant query elements.

19. A method for resolving a bug encountered during development of a computer-executable process comprising:
capturing development and debugging data during development and modification of a computer-executable process;
encountering a bug during execution of the computer-executable process on a computer system;
formulating a query including information related to the encountered bug;
tokenizing the query into one or more relevant query elements and the debugging data into one or more relevant debugging elements;
assigning a weight to each relevant debugging element using term frequency-inverse document frequency weighting;
matching the relevant query elements to the relevant debugging elements;
identifying a first relevant set of data from the debugging data, wherein the first relevant set of data includes one or more first documents that are stored locally on the computer system, the first documents including a first higher-weighted relevant debugging element that matches one or more of the relevant query elements;
identifying a second relevant set of data from the development and debugging data, wherein the second relevant set of data includes one or more second documents that are stored remotely in one or more data repositories, the second documents including a second higher-weighted relevant debugging element that matches one or more of the relevant query elements; and
returning one or more of the first set of relevant data and the second set of relevant debugging data, wherein the second set of relevant data provides a more thorough analysis of the bug than the first set of relevant data;
wherein the development and debugging data includes one or more of hard data and soft data, the hard data including one or more of core dumps, stack traces, hardware configuration data, and data specific to a computer system as it encountered the error, and the soft data including one or more of email threads, meeting notes, whiteboard sessions, version information, code change histories, and portions of code from the computer-executable process.

20. The method of claim 19, further comprising offsetting the assigned weight by a frequency of the relevant debugging element within the captured development and debugging data.
